(19) United States
(12) Patent Application Publication
(10) Pub. No.: US 2026/0354305 A1
(43) Pub. Date: Nov. 12, 2026

(54) MOWER WITH REMOTE STOP

(71) Applicant: ASI Landscaping, LLC, Mendon, UT (US)

(72) Inventors: Davis Thorp Foster, Mendon, UT (US); Logan Meyer, Mendon, UT (US); Roger Dodrill, Mendon, UT (US); Daniel Fu, Mendon, UT (US); Emil Motycka, Mendon, UT (US)

(73) Assignee: ASI Landscaping, LLC, Mendon, UT (US)

(21) Appl. No.: 19/675,455

(22) Filed: May 12, 2026

Related U.S. Application Data
(60) Provisional application No. 63/804,260, filed on May 12, 2025.
(60) Provisional application No. 63/804,187, filed on May 12, 2025.

(51) Int. Cl. A01D 34/00; G05D 1/227; G05D 1/248

(52) U.S. Cl. CPC A01D 34/008; G05D 1/227; G05D 1/248

(57) ABSTRACT

Disclosed are autonomous work vehicles, systems, and methods for monitoring the operation of an autonomous work vehicle. The use of a remote device wirelessly connected to an autonomous work vehicle is monitored during operation. Based on one or more signals produced (or not produced) by the remote device indicating an operator of the remote device is misusing the remote device, one or more operations of the autonomous work vehicle may be paused. The remote device can transmit one or more signals to the autonomous work vehicle (e.g., indicating misuse of the remote device has ended) to cause the one or more operations that were paused to resume such that the autonomous work vehicle resumes autonomous operations.

### BACKGROUND

Autonomous work vehicles operate without an operator controlling the mower. Some autonomous work vehicles can be controlled by the operator using a remote device. For example, a remote device can include safety controls, such as an emergency stop. However, operators may misuse the remote device, which in turn may render the safety controls ineffective.

### SUMMARY

Disclosed are methods, autonomous work vehicles, devices, and systems for verifying control and/or supervision of an autonomous work vehicle. In one aspect a method may comprise receiving, at an autonomous work vehicle operating autonomously, first signals providing a first location of a remote device wirelessly connected to the autonomous work vehicle. The first signals may be provided by a first global navigation satellite system (GNSS) in the remote device. The method may then include providing, by a second GNSS in the autonomous work vehicle, second signals providing a second location of the autonomous work vehicle operating autonomously. The method may then continue by determining whether a distance between the first location and the second location equals or exceeds a threshold, and based on a determination that the distance equals or exceeds the threshold, pausing one or more operations of the autonomous work vehicle to cause the autonomous work vehicle to transition from a higher power consumption state to a lower power consumption state.

The method can further comprise receiving at the autonomous work vehicle, third signals from the remote device providing a third location of the remote device, the third signals associated with the first GNSS, and providing by the second GNSS in the autonomous work vehicle, fourth signals providing a fourth location of the autonomous work vehicle operating autonomously. The method can then continue by determining whether a distance between the third location and the fourth location is less than the threshold, and based on a determination that the distance is less than the threshold, causing the one or more operations of the autonomous work vehicle that were paused to resume operations and cause the autonomous work vehicle to transition from the lower power consumption state to the higher power consumption state. In some embodiments, the method may further comprise prior to receiving the third signals, receiving one or more fifth signals indicating an activation of an input element on the remote device.

The first signals may further comprise one or more signals provided by an accelerometer in the remote device. The method may further comprise analyzing movements of the remote device based on the first signals, determining a sequencing of tasks based on analysis of the movements, and transmitting the sequencing of tasks to a remote device. The method can further comprise, prior to pausing the one or more operations of the autonomous work vehicle, determining whether the autonomous work vehicle is still operating autonomously, and the one or more operations of the autonomous work vehicle are paused based on a determination that the autonomous work vehicle is still operating autonomously. Pausing one or more operations of the autonomous work vehicle may comprise pausing operations of a drive system of the autonomous work vehicle or a cutting mechanism of the autonomous work vehicle.

In another aspect, the method may comprise receiving, at an autonomous work vehicle operating autonomously, signals from a remote device wirelessly connected to the autonomous work vehicle, the signals associated with an accelerometer in the remote device, and determining whether the signals indicate a safety issue with a use of the remote device by an operator of the remote device. Based on a determination that the signals indicate the safety issue, the method may continue by pausing one or more operations of the autonomous work vehicle to cause the autonomous work vehicle to transition from a higher power consumption state to a lower power consumption state.

The signals may comprise first signals, and the method can further comprise receiving at the autonomous work vehicle, second signals from the remote device, the second signals associated with the accelerometer. Based on the second signals, the method can continue by determining that the safety issue has ended, and causing the one or more operations of the autonomous work vehicle that were paused to resume operations and cause the autonomous work vehicle to transition from the lower power consumption state to the higher power consumption state. The second signals may be received from the remote device based on activation of an input element on the remote device. The safety issue can comprise the remote device hanging from an object, and the second signals may be transmitted to the autonomous work vehicle based on the operator picking up the remote device.

The safety issue may be that the operator is not carrying the remote device, and the signals may indicate the remote device is not moving. The safety issue may be that the operator is not carrying the remote device, and the signals may indicate the operator is not carrying the remote device.

The method may further comprise, prior to pausing the one or more operations of the autonomous work vehicle, determining whether the autonomous work vehicle is still operating autonomously, and the one or more operations of the autonomous work vehicle are paused based on a determination that the autonomous work vehicle is still operating autonomously. Pausing one or more operations of the autonomous work vehicle may comprise pausing operations of a drive system of the autonomous work vehicle or pausing operations of a cutting mechanism of the autonomous work vehicle.

In yet another aspect, a system may comprise an autonomous work vehicle, including a first processor, and a first memory storing processor-executable instructions, that when executed by the first processor, cause operations to be performed, the operations comprising receiving one or more first signals from a remote device wirelessly connected to the autonomous work vehicle, the one or more first signals provided by a first global navigation satellite system (GNSS) in the remote device, and receiving one or more second seconds from a second GNSS in the autonomous work vehicle. The instructions may further comprise determining whether a first location of the remote device provided by the one or more first signals and a second location of the autonomous work vehicle provided by the one or more second signals indicate a misuse of the remote device by an operator of the remote device, and based on a determination that the misuse of the remote device is indicated, pausing one or more operations of the autonomous work vehicle. The system may further comprise a remote device operable to connect wirelessly to the autonomous work vehicle, the remote device comprising the first GNSS, a second processor, and a second memory storing processor-executable instructions, that when executed by the second processor, cause operations to be performed. The operations can comprise transmitting one or more third signals to the autonomous work vehicle to cause the autonomous work vehicle to resume the one or more operations of the autonomous work vehicle that were paused.

Misuse of the remote device may comprise the first location being outside a range of the autonomous work vehicle, and the one or more third signals may be transmitted to the autonomous work vehicle when the operator carrying the remote device moves to a third location that is within the range of the autonomous work vehicle. The instructions may further comprise, prior to pausing the one or more operations of the autonomous work vehicle, determining whether the autonomous work vehicle is still operating autonomously, and the one or more operations of the autonomous work vehicle can be paused based on a determination that the autonomous work vehicle is still operating autonomously. Pausing one or more operations of the autonomous work vehicle may comprise pausing operations of a drive system of the autonomous work vehicle or pausing some or all of the operations of a cutting mechanism of the autonomous work vehicle.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 illustrates a block diagram of an example autonomous work vehicle communication system of the present disclosure.

FIG. 2 is a side view of an autonomous yard truck according to some embodiments.

FIG. 3 is a perspective view of an autonomous mower according to some embodiments.

FIG. 4 is a side view of an autonomous tractor according to some embodiments.

FIG. 5 shows an isometric view of an example autonomous mower suitable for use with a remote device according to an embodiment of the disclosure.

FIG. 6 illustrates another isometric view of the example autonomous mower shown in FIG. 5.

FIG. 7 shows an operator carrying a remote device according to an embodiment of the disclosure.

FIG. 8 illustrates a flowchart of an example method of operating a mower with a remote device according to an embodiment of the disclosure.

FIG. 9 illustrates a flowchart of an example method of determining work routes according to an embodiment of the disclosure.

FIG. 10 shows a block diagram of an example computational system for a remote device according to an embodiment of the disclosure.

FIG. 11 illustrates a block diagram of an example computational system for an autonomous work vehicle according to an embodiment of the disclosure.

### DETAILED DESCRIPTION

Autonomous work vehicle systems conventionally rely on exteroceptive sensors to navigate within an operating environment. However, such sensors can sometimes fail to capture or represent obstacles within the operating environment and/or sensor data received from such sensors can fail to be interpreted correctly, such that the autonomous work vehicle may fail to recognize or respond inappropriately to an obstacle within the operating environment. Supervision of such autonomous work vehicles may be required as autonomous operation of work vehicles continues to improve, for example, until confidence in autonomous operation rises to sufficient levels.

Disclosed are autonomous work vehicles, systems, and methods for verifying operation and control of an autonomous work vehicle. Specifically, an operator may be present within an operating environment to oversee or supervise operation of the autonomous work vehicle and may be capable of pausing autonomous operation of the vehicle, for example, when the autonomous work vehicle malfunctions or operates in an undesirable manner. For example, the operator may fill a supervisory role while performing additional work near (e.g., within sight of) the autonomous work vehicle. A remote device on the person of the operator may be used to verify continuing supervision of the autonomous work vehicle by the operator. The remote device may be used to control the autonomous work vehicle (e.g., to instruct the autonomous work vehicle to execute an emergency stop) and information from the remote device may be used to verify that the remote operator maintains the remote device within reach for control of the autonomous work vehicle.

Signals sent from the remote device (e.g., to a computing device and/or to the autonomous work vehicle) may indicate a status of the operator. For example, position signal data from the remote device may be compared to position signal data from the autonomous work vehicle to verify that the operator is in the vicinity of the autonomous work vehicle. In another example, position signal data from the remote device may be used to determine that the operator is moving within the operating environment and is not distracted or otherwise incapacitated. If the location signal data indicates that the operator is not actually or adequately supervising the autonomous work vehicle, the operation of the autonomous work vehicle may be paused, for example, by implementing an emergency stop, interrupting operation of an attached implement of the autonomous work vehicle, or by otherwise stopping or pausing operation of the autonomous work vehicle. The operation of the autonomous work vehicle may resume when supervision verification resumes, for example, based on data from the remote device and/or the autonomous work vehicle.

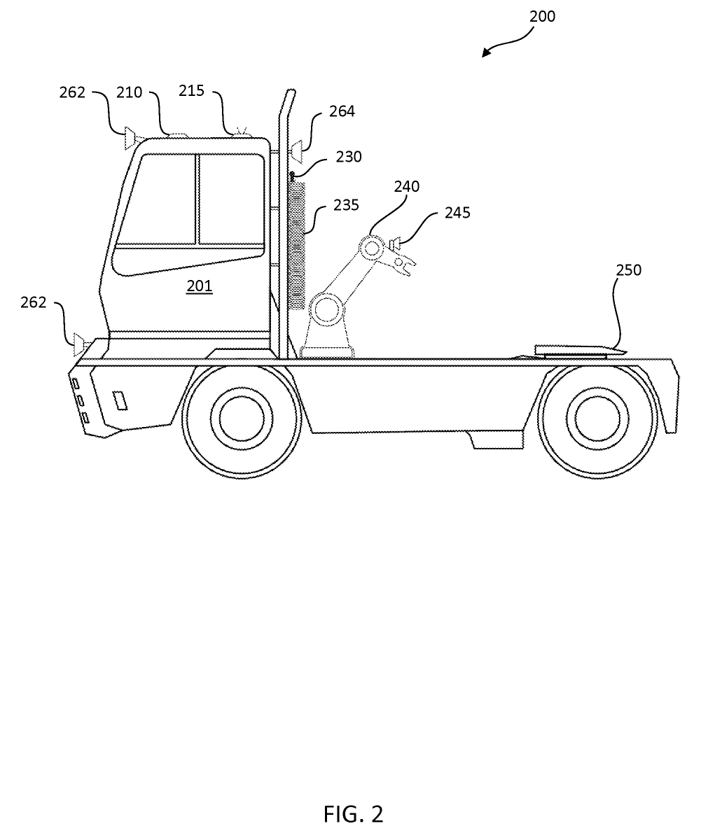

As used herein, the term “autonomous work vehicle” may refer to a vehicle configured to perform a task within an operating environment. The autonomous work vehicle may refer to a vehicle that may be driven by an autonomous system with little or no human input. The autonomous work vehicle may refer to a driving unit (e.g., a tractor) attached to an implement, or may refer to the driving unit as distinct from the implement. Examples of autonomous work vehicles are shown in FIGS. 2, 3, 4, 5, and 6. While these figures show examples of an autonomous yard truck, mower, and tractor the term “autonomous work vehicle” refers to any type of autonomous vehicle that is can be used to perform a specific job other than driving autonomously.

As used herein, the term “implement” may refer to a device connected (detachably or permanently) to an autonomous work vehicle, and which is configured to interface and/or interact with objects (beyond the vehicle to which it is connected) within the operating environment. The implement may include farming implements, construction implements, mowing implements, or other vehicle attachments. The implement may include a vehicle connection point for detachably and/or pivotably connecting the implement to a vehicle (e.g., an autonomous work vehicle). The implement may be configured, for example, to move objects within the operating environment, to cut or partition objects, or to bind objects together. The implement may be configured to interface with a ground surface of the operating environment, vegetation, crops, sod, grass, etc.

As used herein, the term “autonomous vehicle system,” “autonomous work vehicle system,” or related terms may refer to the combination of the autonomous work vehicle hardware (including sensors), an attached implement (including sensors), and the software that enables the vehicle to perform an operational task autonomously. The term may refer to the autonomous work vehicle and an attached implement, and/or may include the software and hardware for executing the methods described below and/or the computer-readable media storing such methods. In some embodiments, the term may additionally include the base station that communicates with the autonomous work vehicle. In some embodiments, the term may additionally include a kit that can be installed on a vehicle that may allow the vehicle to operate autonomously.

As used herein, the term “operator” may refer to a manual driver of the work vehicle, who may be present within the cab of the vehicle or may refer to a remote operator that drives the work vehicle from a distance. The operator may refer to a remote operator that may receive sensor data from the work vehicle to drive, manage, and/or troubleshoot the work vehicle from a distance. For example, if the autonomous work vehicle pauses or stops (e.g., due to encountering an unknown situation or an operational or sensor failure), a remote operator may receive sensor data (e.g., an image of an unexpected obstacle) of the operating environment, and the remote operator may then upon examination of the sensor data configure the autonomous work vehicle to resume operation. In some embodiments, the operator may refer to a technician that services the work vehicle for maintenance and repair, and/or who may troubleshoot the work vehicle, especially during operational pauses of the work vehicle (e.g., autonomous work vehicle).

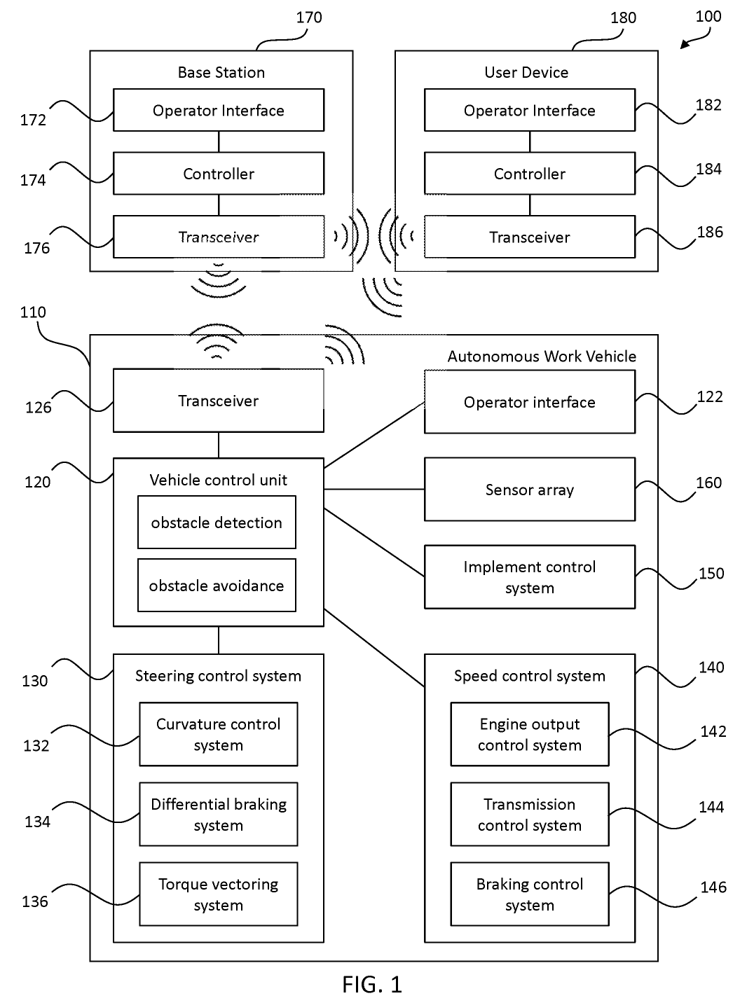

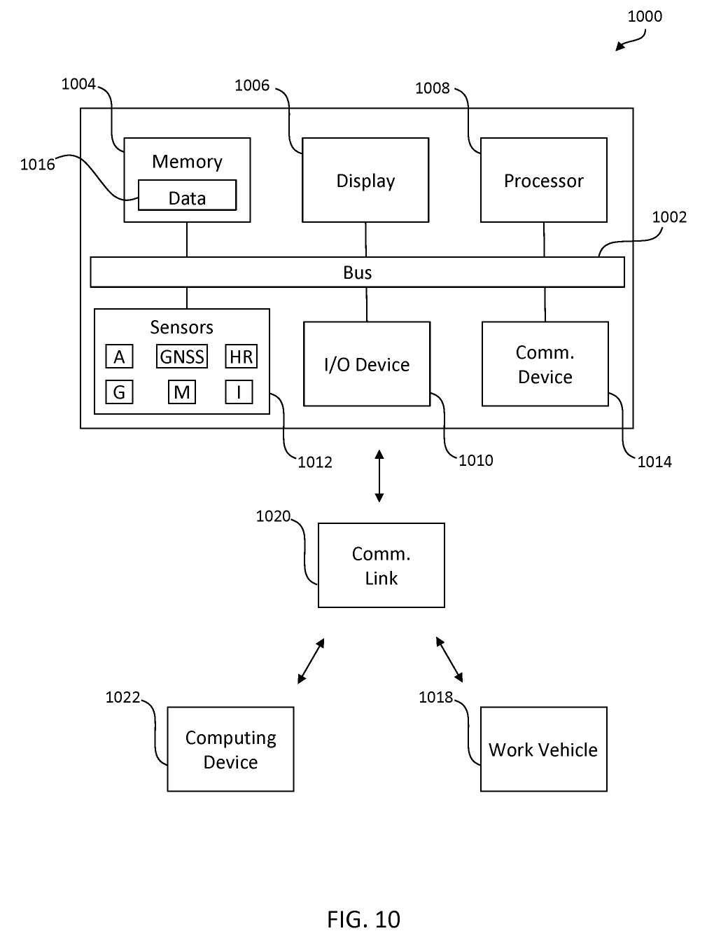

FIG. 1 is a block diagram of a communication and control system 100 that may be utilized in conjunction with the systems and methods of the disclosure. The communication and control system 100 may include a vehicle control unit 120 which may be mounted on an autonomous work vehicle 110. The autonomous work vehicle 110, for example, may include a yard truck, loader, wheel loader, track loader, dump truck, digger, backhoe, forklift, mower (e.g., lawn, field, or brush mower), or other work vehicle. The communication and control system 100, for example, may include any or all components of computational system 1000 shown in FIG. 10, described below.

For example, the autonomous work vehicle 110 may include a steering control system 130 that may control a direction of movement of the autonomous work vehicle 110. The steering control system 130, for example, may include any or all components of computational system 1000 shown in FIG. 10.

The autonomous work vehicle 110, for example, may include a speed control system 140 that controls the speed, acceleration, and deceleration of the autonomous work vehicle 110. The speed control system 140, for example, may control the speed of the autonomous work vehicle 110 based on map data, control algorithms, obstacle detection, start and/or stop points, input from the operator (e.g., a remote operator), etc. The speed control system 140, for example, may include any or all components of computational system 1000 shown in FIG. 10.

The autonomous work vehicle 110, for example, may include an implement control system 150 that may control operation of an implement towed by the autonomous work vehicle 110, integrated within the autonomous work vehicle 110, or coupled to the autonomous work vehicle 110. The implement control system 150, for example, may include any type of implement such as, for example, a bucket, a shovel, a blade, a thumb, a dump bed, a plow, an auger, a trencher, a scraper, a broom, a hammer, a grapple, forks, boom, spears, a cutter, a wrist, a tiller, a rake, etc. The implement control system 150, for example, may include any or all components of computational system 1000 shown in FIG. 10.

The vehicle control unit 120 may be communicatively coupled with the steering control system 130, the speed control system 140, and/or the implement control system 150. The vehicle control unit 120, for example, may include any or all of the components shown in FIG. 10. The vehicle control unit 120, for example, may be integrated into a single controller or may include a plurality of distinct components or controllers. The vehicle control unit 120 may also be coupled with one or more sensors from the sensor array 160 and receive sensor data from the sensor array 160.

The vehicle control unit 120, for example, may be used to control various aspects of the autonomous work vehicle 110 such as, for example, sending instructions to the steering control system 130, speed control system 140, implement control system 150, etc. The vehicle control unit 120, for example, may include a vehicle artificial intelligence (VAI) that may include one or more processors that execute one or more algorithms, including methods 800 and/or 900 disclosed below.

The vehicle control unit 120, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, and the like, or any combination thereof. These signals, for example, may come from the sensor array 160 or from a base station 170 (described below).

The vehicle control unit 120, for example, may be an electronic controller with electrical circuitry configured to process data from the various components of the autonomous work vehicle 110. The vehicle control unit 120 may include a processor, such as the processor 1210, and a working memory 1235. The vehicle control unit 120 may also include one or more storage devices, storage media, and/or other suitable components of computational system 1200. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors. The vehicle control unit 120, for example, may include any or all the components shown in FIG. 10.

The vehicle control unit 120, for example, may include a volatile memory, such as random access memory (RAM), and/or a nonvolatile memory, such as ROM (e.g., working memory 1235, storage device 1225, and/or other (e.g., non-transitory) computer-readable media). The memory may store a variety of information and may be used for various purposes. For example, the memory may store processor-executable instructions (e.g., firmware or software) for the vehicle control unit 120 to execute, such as instructions for calculating a drivable path plan, and/or controlling the autonomous work vehicle 110 (e.g., for implementing methods 800 and/or 900 below). The memory may include flash memory, one or more hard drives, or any other suitable optical, magnetic, or solid-state storage medium, or a combination thereof. The memory may store data such as field maps, maps of desired paths, vehicle characteristics, software or firmware instructions, and/or any other suitable data.

The steering control system 130, for example, may include a curvature rate control system 132, a differential braking system 134, a steering mechanism, and a torque vectoring system 136 that may be used to steer the autonomous work vehicle 110. The curvature rate control system 132, for example, may control a direction of an autonomous work vehicle 110 by controlling a steering control system of the autonomous work vehicle 110 with a curvature rate, such as an Ackerman style autonomous work vehicle 110 or articulating vehicle. The curvature rate control system 132, for example, may automatically rotate one or more wheels or tracks of the autonomous work vehicle 110 via hydraulic or electric actuators to steer the autonomous work vehicle 110. By way of example, the curvature rate control system 132 may rotate front wheels/tracks, rear wheels/tracks, and/or intermediate wheels/tracks of the autonomous work vehicle 110 or articulate the frame of the vehicle, either individually or in groups. The differential braking system 134 may independently vary the braking force on each lateral side of the autonomous work vehicle 110 to direct the autonomous work vehicle 110. Similarly, the torque vectoring system 136 may differentially apply torque from the engine to the wheels and/or tracks on each lateral side of the autonomous work vehicle 110. While the illustrated steering control system 130 includes the curvature rate control system 132, the differential braking system 134, and the torque vectoring system 136, the steering control system 130 may include one or more of these systems. Further examples may include a steering control system 130 having other and/or additional systems to facilitate turning the autonomous work vehicle 110 such as an articulated steering control system, a differential drive system, and the like.

The speed control system 140, for example, may include an engine output control system 142, a transmission control system 144, and a braking control system 146. The engine output control system 142 may vary the output of the engine to control the speed of the autonomous work vehicle 110. For example, the engine output control system 142 may vary a throttle setting of the engine, a fuel/air mixture of the engine, a timing of the engine, and/or other suitable engine parameters to control engine output. In addition, the transmission control system 144 may adjust gear selection within a transmission to control the speed of the autonomous work vehicle 110. Furthermore, the braking control system 146 may adjust the braking force to control the speed of the autonomous work vehicle 110. While the illustrated speed control system 140 includes the engine output control system 142, the transmission control system 144, and the braking control system 146, the speed control system 140 may include one or two of these systems. The speed control system 140, for example, may also include other systems and/or additional systems that may be used to control the speed of the autonomous work vehicle 110.

The implement control system 150, for example, may control various parameters of the implement towed by and/or integrated within the autonomous work vehicle 110. For example, the implement control system 150 may instruct an implement controller via a communication link, such as a CAN bus, ISOBUS, Ethernet, wireless communications, and/or Broad R Reach type Automotive Ethernet, etc.

The implement control system 150, for example, may instruct an implement controller to adjust a penetration depth of at least one ground engaging tool of an agricultural implement, which may reduce the draft load on the autonomous work vehicle 110.

The implement control system 150, as another example, may instruct the implement controller to transition an agricultural implement between a working position and a transport position, to adjust a flow rate of product from the agricultural implement, to adjust a position of a header of the agricultural implement (e.g., a harvester, etc.), among other operations, etc. The implement control system 150, as another example, may instruct the implement controller to adjust a shovel height, a shovel angle, a shovel position, etc.

The communication and control system 100, for example, may include a sensor array 160. The sensor array 160, for example, may facilitate determination of condition(s) of the autonomous work vehicle 110 and/or the work area. For example, the sensor array 160 may include one or more sensors (e.g., infrared sensors, ultrasonic sensors, magnetic sensors, tachometer, radar sensors, LiDAR sensors, terahertz sensors, sonar sensors, wheel encoders, cameras, etc.) that monitor a rotation rate of a respective wheel and/or track a ground speed of the autonomous work vehicle 110. The sensors may also monitor operating levels (e.g., temperature, fuel level, etc.) of the autonomous work vehicle 110. Furthermore, the sensors may monitor conditions in and around the work area, such as temperature, weather, wind speed, compass, humidity, and other conditions. The sensors of the sensor array 160, for example, may detect physical objects in the work area, such as a parking stall, a material stall, accessories, other vehicles, obstacles, environmental features, or other object(s) that may be in the area surrounding the autonomous work vehicle 110.

The sensor array 160, for example, may include a velocity sensor which may include one or more of an inertial measurement unit, a compass, a GPS sensor, a wheel encoder, a tachometer, a camera, a radar, etc. The sensor array 160, for example, may also include a steering angle sensor. The velocity sensor, for example, may produce velocity data. Velocity data may include information regarding speed and/or bearing. Velocity data, for example, may additionally, or alternatively, include information regarding the steering angular rate.

The autonomous work vehicle 110 may include an operator interface 122 for controlling the vehicle. The operator interface 122, for example, may be communicatively coupled to the vehicle control unit 120 and configured to present data from the autonomous work vehicle 110 via a display. Display data may include data associated with operation of the autonomous work vehicle 110, data associated with operation of an implement, a position of the autonomous work vehicle 110, a speed of the autonomous work vehicle 110, a desired path, a drivable path plan, a target position, and/or a current position, etc. The operator interface 122 may enable an operator to control certain functions of the autonomous work vehicle 110 such as starting and stopping the autonomous work vehicle 110, inputting a desired path, etc. The operator interface 122, for example, may enable the operator to input parameters that cause the vehicle control unit 120 to adjust the drivable path plan. For example, the operator may provide an input requesting that the desired path be acquired as quickly as possible, that an off-path normal error be minimized, that a speed of the autonomous work vehicle 110 remain within certain limits, and/or that a lateral acceleration experienced by the autonomous work vehicle 110 remain within certain limits, etc. In addition, the operator interface 122 (e.g., via the display, or via an audio system (not shown), etc.) may alert an operator if the desired path cannot be achieved, for example.

The communication and control system 100, for example, may include a base station 170 having a base station controller 174 located remotely from the autonomous work vehicle 110. For example, the control functions of the vehicle control unit 120 may be distributed between the vehicle control unit 120 of the autonomous work vehicle 110 and the base station controller 174. The base station controller 174, for example, may perform a substantial portion of the control functions of the vehicle control unit 120. For example, a first transceiver 126 positioned on the autonomous work vehicle 110 may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 176 at the base station 170. The base station controller 174, for example, may calculate drivable path plans and/or output control signals to control the curvature control system 132, the speed control system 140, and/or the implement control system 150 to direct the autonomous work vehicle 110 toward the desired path, for example. The base station controller 174 may include a processor and memory device having similar features and/or capabilities as the processor and the memory device discussed previously. Likewise, the base station 170 may include an operator interface 172 having a display, which may have similar features and/or capabilities as the operator interface 122 and the display discussed previously.

In some embodiments, one or both of the base station 170 and/or the autonomous work vehicle 110 may be in communication with a user device 180. A user device 180 may include a phone, tablet, laptop, or computer. The user device 180 may similarly include an operator interface 182 which may include similar features and capabilities as operator interfaces 122, 172 described above. Additionally, or alternatively, the user device 180 may include a controller 184 that may include the same or similar features, components, and/or characteristics as the controller 174 of the base station 170. For example, the controller 184 of the user device 180 may calculate drivable path plans, output control signals to control the curvature control system 132, the speed control system 140, and/or the implement control system 150 to direct the autonomous work vehicle 110. The user device 180, for example, can include an application that allows the user (e.g., a remote operator) to communicate commands to the autonomous work vehicle 110 (e.g., via a transceiver 186) and/or receive information about the autonomous work vehicle 110. Alternatively, or additionally, the user device 180, for example, can include an application that allows the operator to observe the autonomous work vehicle 110 move through a map of the work area where the autonomous work vehicle operates.

The user device 180, for example, may include an application that can receive an indication associated with the remote operator or which can receive other user or operator inputs. The user device 180, for example, may include an application that can display any of the information disclosed in this document.

FIG. 2 is a side view of an autonomous yard truck 200 according to some embodiments. The autonomous yard truck 200 is an example of an autonomous work vehicle. The autonomous yard truck 200 includes a cab 201 that may be used to drive the autonomous yard truck 200 manually. The autonomous yard truck 200 may include one or more of the components shown in FIG. 1. The autonomous yard truck 200 may also include a brake system, an engine, a transmission, steering, sensor array, etc. such as, for example, as shown in FIG. 1.

In some embodiments, the autonomous yard truck 200 may include a sensor array that includes sensors 262 (e.g., sensor array 160) disposed at various locations on the autonomous yard truck 200 such as, for example, on the cab 201, bumper, housing, frame, etc. The sensors 262 may include infrared sensors, ultrasonic sensors, magnetic sensors, radar sensors, LiDAR sensors, terahertz sensors, sonar sensors, cameras, etc. The sensor array of the autonomous yard truck 200 may also include one or more backup sensors 264 such as, for example, infrared sensors, ultrasonic sensors, magnetic sensors, radar sensors, LiDAR sensors, terahertz sensors, sonar sensors, cameras, etc.

In some embodiments, the autonomous yard truck 200 may include a spatial locating device (or GPS) antenna 210. In some embodiments, the autonomous yard truck 200 may include a transceiver antenna 215.

In some embodiments, the autonomous yard truck 200 may include one or more hoses 235 that can connect with a trailer such as, for example, two or three hoses. Each hose may have a hose connector 230 that can connect with a trailer hose connector. For example, the one or more hoses 235 of the autonomous yard truck 200 may include a service brake hose, an emergency brake hose, and/or a refrigerant hose.

In some embodiments, the autonomous yard truck 200 may include a robotic arm 240 disposed on the back bed of the autonomous yard truck 200. The robotic arm 240 may include any type of robotic arm. The robotic arm 240, for example, may exert high torque or high pressure sufficient to connect the hose connector 230 with the trailer hose connector. The hose connector 230 and/or the trailer hose connector may include a glad-hand connector. In some embodiments, when the autonomous yard truck 200 is not coupled with a trailer, the hose connector 230 may be positioned in a storage rack at some point on the autonomous yard truck 200 such as, for example, on the rear of the cab 201.

In some embodiments, the robotic arm 240 may include one or more arm sensors 245 such as, for example, infrared sensors, ultrasonic sensors, magnetic sensors, radar sensors, LiDAR sensors, terahertz sensors, sonar sensors, cameras, etc. The arm sensor 245, for example, may produce data that can be used to identify the location of a hose connector 230 and/or a trailer hose connector. The arm sensor 245, for example, may produce data that can show that a hose connector 230 and/or a trailer hose connector are sufficiently coupled.

In some embodiments, the autonomous yard truck 200 may include a fifth-wheel coupling 250. The fifth-wheel coupling 250, for example, may be raised or lowered with a fifth-wheel coupling boom. FIG. 2 shows the fifth-wheel coupling 250 in a lowered position. The fifth-wheel coupling 250 may couple with a kingpin of a trailer.

When the fifth-wheel coupling 250 is coupled with a kingpin and the fifth-wheel coupling 250 is in the raised position, the legs of the trailer may lift off the ground (e.g., automatically). This may allow the autonomous yard truck 200 to pull the trailer without individually raising the trailer legs.

In some embodiments, the robotic arm 240 and/or the arm sensor 245 may be coupled with a thermal management system. A thermal management system may, for example, be coupled with a thermal management system associated with the autonomous yard truck 200 such as, for example, coupled with the cab heating/cooling system and/or the engine heating/cooling system. A thermal management system may, for example, be an independent system that heats and/or cools the robotic arm 240 and/or the arm sensor 245. A thermal management system may, for example, keep the temperature of the robotic arm 240 and/or the arm sensor 245 between about 32º F and about 100º F.

In some embodiments, the autonomous yard truck 200 may include a deployable shade coupled with the back of the cab 201. The deployable shade, for example, may be used to screen the sun and/or other lighting from the arm sensor 245 and/or the one or more backup sensors 264. The deployable shade, for example, may include an umbrella configuration or an awning configuration. The deployable shade, for example, may be coupled with the roof or an upper portion of the cab.

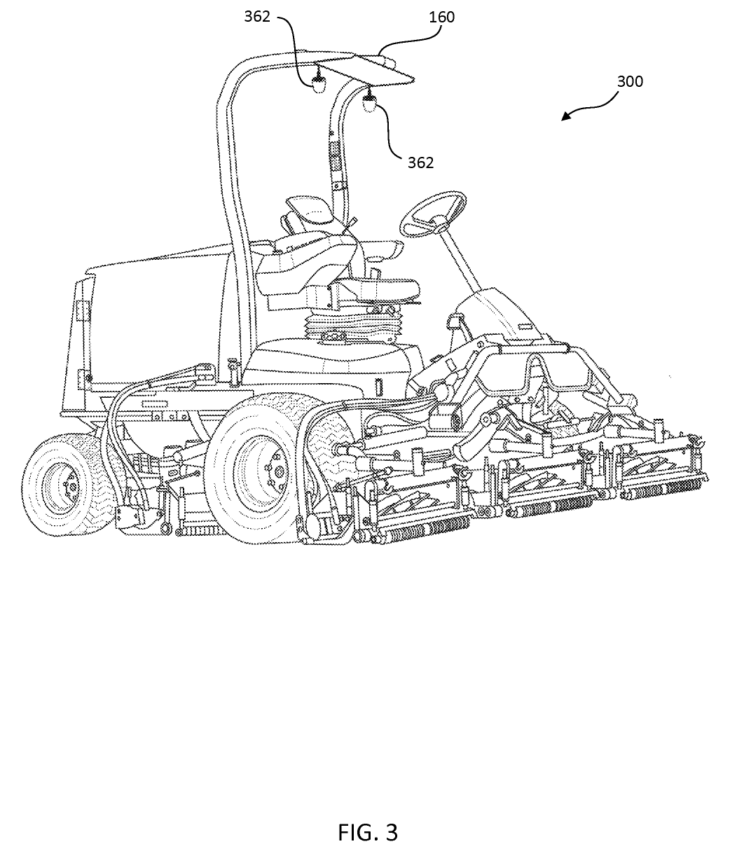

FIG. 3 is a side view of an example autonomous mower 300, which may include all or some of the components of autonomous work vehicle 110. The autonomous mower 300 is an example of an autonomous work vehicle. The autonomous work vehicle in this document may include the autonomous mower 300. Any type of mower or blades may be used, such as a disc mower. The autonomous mower 300, for example, may include a sensor array 160 (or multiple sensor arrays 160), including sensors 362. The sensor array 160 may include, for example, one or more LiDAR, radar, and/or video cameras. The video cameras, for example, may include 360 degree cameras, a front facing camera, and/or a back facing camera.

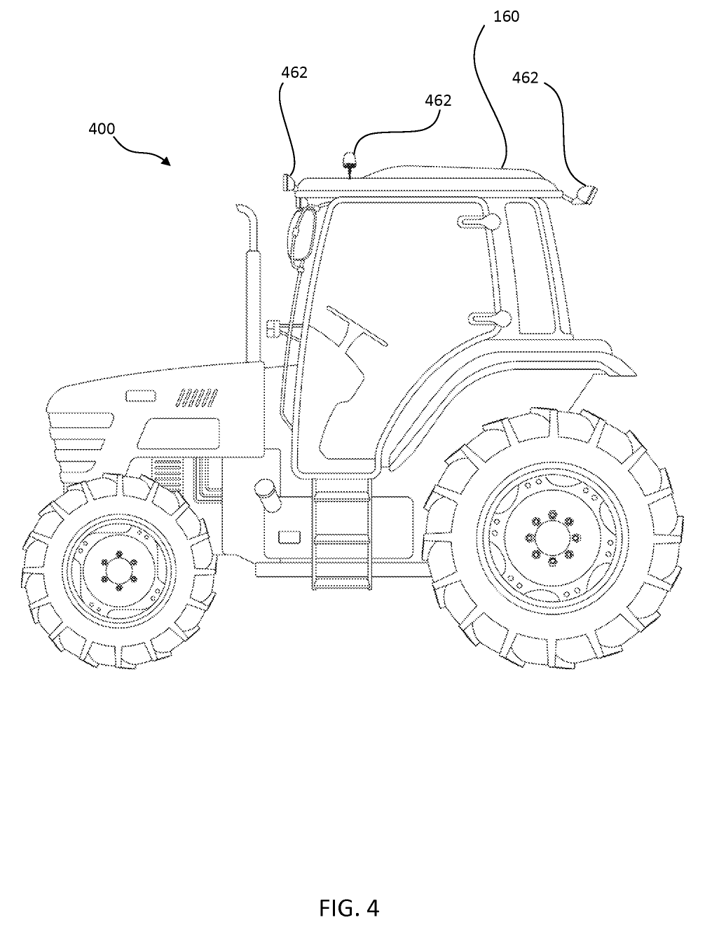

FIG. 4 is a side view of an example autonomous tractor 400, which may include all or some of the components of autonomous work vehicle 110. The autonomous tractor 400 is an example of an autonomous work vehicle. The autonomous work vehicle in this document may include the autonomous tractor 400. In this example, the autonomous tractor 400 may include standard tractor equipment and/or components. The autonomous tractor 400 may include or be coupled with any kind of implement such as, for example, a plow, disc plow or disc harrow, reel mower, dumper, lift, bucket, shovel, blade, and/or cutter, etc. The autonomous tractor 400, for example, may include a sensor array 160 (or multiple sensor arrays 160), including sensor(s) 462. The sensor array 160 may include, for example, one or more LiDAR, radar, and/or video cameras. The video cameras, for example, may include 360 degree cameras, a front facing camera, and/or a back facing camera.

The following description of certain embodiments is merely exemplary in nature and is in no way intended to limit the scope of the disclosure or its applications or uses. In the following detailed description of embodiments of the present systems and methods, reference is made to the accompanying drawings which form a part hereof, and which are shown by way of illustration specific embodiments in which the described systems and methods may be practiced. These embodiments are described in sufficient detail to enable those skilled in the art to practice presently disclosed systems and methods, and it is to be understood that other embodiments may be utilized and that structural and logical changes may be made without departing from the spirit and scope of the disclosure. Moreover, for the purpose of clarity, detailed descriptions of certain features will not be discussed when they would be apparent to those with skill in the art so as not to obscure the description of embodiments of the disclosure. The following detailed description is therefore not to be taken in a limiting sense, and the scope of the disclosure is defined only by the appended claims.

Mowers that operate autonomously can be controlled, at least to some degree, with a remote device that is connected wirelessly to the mower. For safety reasons, an operator of a remote device (i.e., a remote operator) may be required to always carry the remote device so that the operator has quick access to one or more safety controls on the remote device. The safety controls can include a pause button that pauses (e.g., temporarily stops) some of the operations of the mower and a stop button that stops and turns off the mower.

Embodiments disclosed herein may provide techniques for monitoring the use of a remote device based on one or more signals that are produced by the remote device. When it is determined that the operator is not carrying the remote device, some of the operations of the mower can be paused. For example, one or more drive systems (e.g., the steering control system 130 and/or the speed control system 140) or components thereof, such as motors, transmissions, and associated control electronics, can be paused (e.g., temporarily stopped) to stop the movement of the mower. Additionally, or alternatively, in some embodiments, some or all of the operations of the cutting mechanism may be paused. The cutting mechanism of the autonomous mower can include the mower reel, cutting blades (and/or a motor attached thereto), a crankshaft, belts and pulleys, spindles, and so on. In addition to ensuring the operator has access to the safety controls on the remote device while the autonomous mower is operating, stopping the movement of the autonomous mower and pausing some of the operations of the autonomous mower may cause the autonomous mower to transition from a higher power consumption state to a lower power consumption state that saves battery power. For example, a drive system of the autonomous mower can be paused or stopped temporarily to bring the autonomous mower to a controlled stop or idle. Additionally, or alternatively, some or all of the operation cutting mechanism, such as the mower reel and/or cutting blades, can be paused to save power. The operations that were paused can be un-paused (e.g., resume) based on signals that indicate the operator has picked up and now carries the remote device. In one embodiment, in addition to picking up and carrying the remote device, the operator may be required to activate an input element, such as a button on the remote device, to un-pause the operations of the autonomous mower and allow the autonomous mower to resume autonomous operation.

One or more sensors may also be used to track the movements of the operator or the members of a landscaping crew as they work in a landscaping area. For example, remote devices can include position sensors, such as a global navigation satellite system (GNSS) sensor. Similarly, other items carried by the operator and the members of the landscaping crew, such as vests or protective equipment (e.g., gloves or hats), may include position sensors. The signals from the position sensors can be received by one or more processors in the remote device, the autonomous mower, or a separate computing device and processed to determine more efficient work routes for the landscaping area.

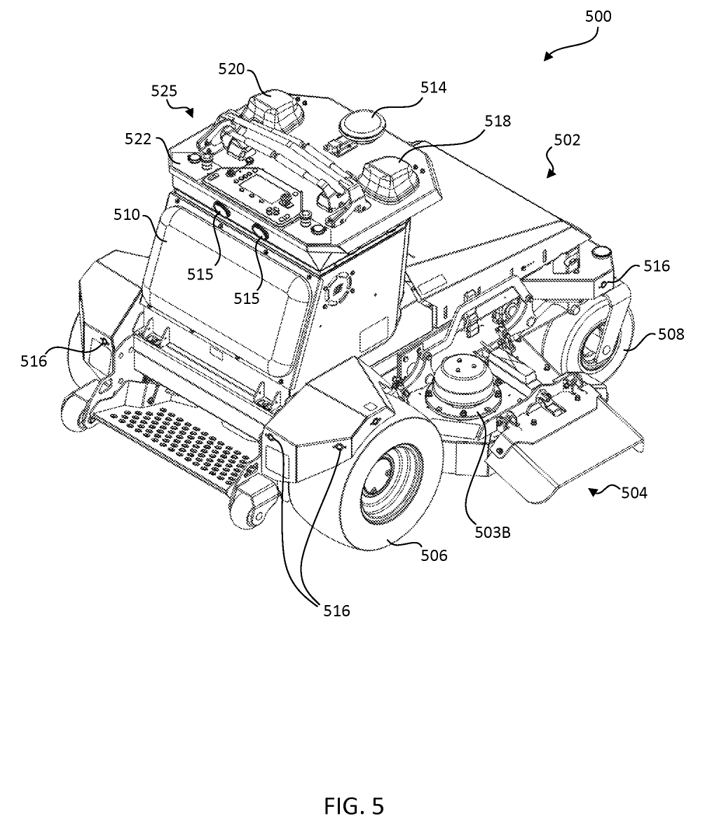

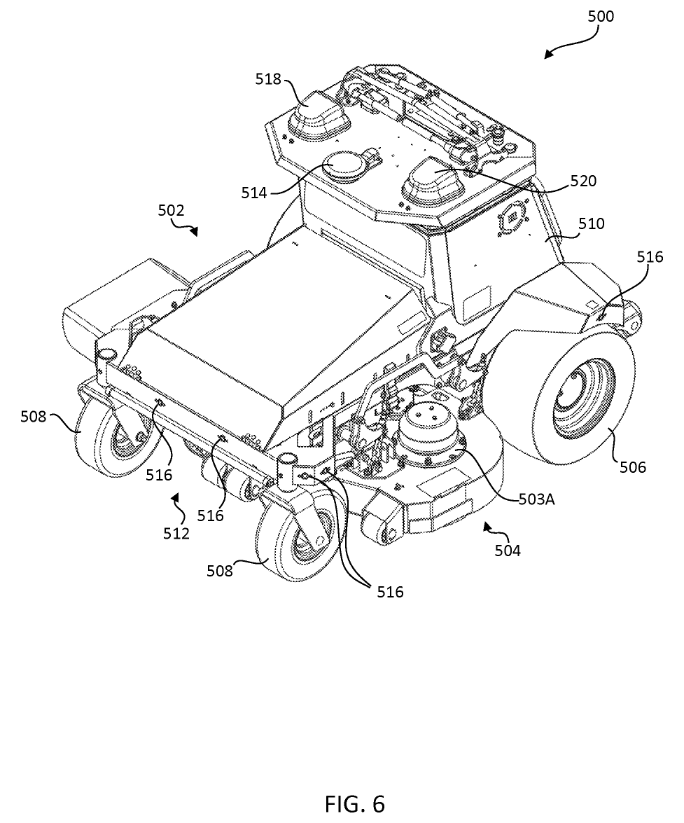

FIG. 5 and FIG. 6 illustrate different isometric views of an example autonomous mower 500 suitable for use with a remote device according to an embodiment of the disclosure. These autonomous mowers are examples of an autonomous work vehicle. The autonomous mower 500 may include a chassis 502 with a drive system (e.g., motors 503A, 503B) and a mowing deck 504, rear wheels 506, front wheels 508, and a body 510. The body 510 can house components such as the battery or batteries, motors, and various control electronics, and the mowing deck 504 can house the cutting blades and other components of the cutting mechanism. In other embodiments, the autonomous mower 500 may comprise a mower reel assembly having a mower reel, similar to the autonomous mower 300 of FIG. 3, instead of a mowing deck 504. The rear wheels 506 may be drive wheels and the front wheels 508 may be follower-type casters in one embodiment. The drive system may cause the rear wheels 506 to rotate, propelling the autonomous mower 500 in a desired direction. Steering can be accomplished by differential rotational speeds and/or directions of the rear wheels 506.

In some embodiments, the autonomous mower 500 is capable of operating autonomously without input from an operator (e.g., an operator riding on and steering the mower). The autonomous mower 500 may rely at least on cameras, sensors, and/or wireless systems for autonomous operations. Accordingly, the autonomous mower 500 can include one or more cameras 515 (FIG. 5), one or more bump sensors 512, a global navigation satellite system (GNSS) antenna 514, and position sensors 516. In the illustrated embodiment, the autonomous mower 500 includes eight cameras, with two cameras (a stereo pair) facing each direction (forward, backward, and both sides) and the position sensors 516 are located around the autonomous mower 500 and may include ultrasonic sensors.

The autonomous mower 500 further includes one or more radomes 518, 520 that cover various antennas. In some embodiments, the antennas include a long range radio (LoRa) antenna, a cellular and/or a WiFi antenna, and/or a Bluetooth antenna. The autonomous mower 500 can include additional sensors, such as environmental sensors, motion sensors, wheel rotation sensors (e.g., rotary encoders, Hall Sensors, etc.), proximity sensors, acoustic sensors, Inertial Measurement Units (IMUs) that may comprise accelerometers, gyroscopes, and magnetometers, and the like. The additional sensors may be positioned at various locations around the autonomous mower 500 and/or within the body 510 of the autonomous mower 500.

The autonomous mower 500 can include an instrument panel 522 having one or more input elements (e.g., buttons) and output elements (e.g., display) and a computing unit 525. The computing unit 525 may be housed within the body 510 of the autonomous mower 500. The computing unit 525 may include one or more processors (e.g., processor 1008 of FIGS. 10 – 11), one or more storage devices (e.g., memory 1004), and processor-executable instructions (e.g., one or more software applications) stored on the storage device(s). The computing unit 525 may be configured to receive signals from the cameras 515, the bump sensor(s) 512, the position sensors 516, the additional sensors, and/or one or more of the antennas while the autonomous mower 500 is operating.

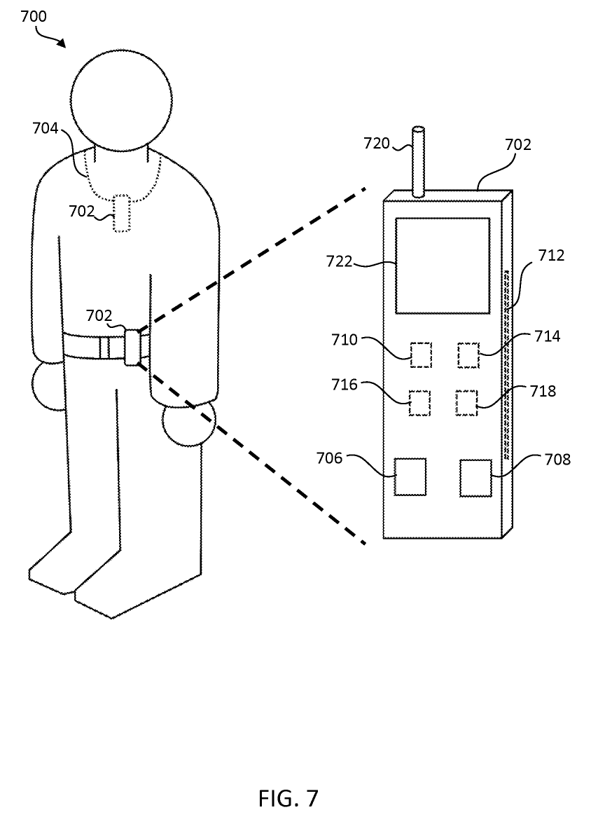

The autonomous mower 500 can be configured to operate with a remote device that is carried by an operator 700 (shown in FIG. 7). The remote device may produce signals to enable the use of the remote device to be monitored. If the signals indicate misuse by the operator, which can be a safety issue, operation of the autonomous mower 500 can be paused. When paused, the autonomous mower 500 can come to a controlled stop (e.g., without harming any of the components of the autonomous mower 500) and the power consumption of the autonomous mower can be reduced (e.g., by entering a sleep mode of the autonomous mower 500). In one embodiment, the signals produced by the remote device are transmitted to the autonomous mower 500 for monitoring. The autonomous mower 500 may determine whether the remote device is being misused, and if so, pause the movement and/or some of the operations of the autonomous mower 500.

FIG. 7 illustrates an operator 700 carrying a remote device 702 according to an embodiment of the disclosure. The remote device 702 may transmit and receive signals from an autonomous work vehicle that is connected wirelessly to the remote device 702. The operator 700 may be an operator of the autonomous work vehicle or the operator can be a member of a landscaping crew that is working in a landscaping area with the autonomous work vehicle. The operator 700 may carry the remote device 702 as the operator 700 performs various functions within the range of the autonomous work vehicle. For example, the operator 700 can trim bushes or trees, plant various flowers or greenery, or perform other functions. The operator 700 can carry the remote device 702 using any suitable technique. For example, as shown in FIG. 7, the remote device 702 may be attached to a belt or to the waist of the operator’s pants by a clip or a holster (not shown). In other embodiments, the remote device 702 may be attached to a lanyard 704 that is worn around the operator’s neck. In some instances, the operator 700 can carry the remote device 702 in his or her hands.

The remote device 702 can include one or more input elements. For example, input elements of the remote device 702 can include a pause button 706 to pause operations of the autonomous work vehicle and a stop button 708 to stop the operations of the autonomous work vehicle completely (e.g., an emergency stop). In the illustrated embodiment, the pause button 706 and the stop button 708 (and/or other input elements) are physical buttons. In other embodiments, the pause button 706 and/or stop button 708 (and/or other input elements) can be virtual buttons displayed on a touchscreen, a microphone to receive voice commands, and other types of input elements.

The remote device 702 may include one or more sensors. For example, the remote device 702 can include a heart rate sensor 710 to detect a heartbeat of the operator 700. The remote device may further include a touch or pressure sensor 712 to detect whether the operator 700 is carrying the remote device 702 (e.g., holding in his or her hands). The remote device 702 can include additional or alternate sensors, such as a motion sensor 714, an orientation sensor 716, and/or an image sensor 718 (e.g., a camera).

As described earlier, the remote device 702 is configured to receive and transmit signals to the autonomous work vehicle. The signals may be received and transmitted via one or more antennas 720. In some embodiments, the antenna(s) 720 includes a LoRa antenna, a cellular and/or a WiFi antenna, and/or a Bluetooth antenna, although other embodiments can include different or additional antennas.

In some embodiments, the remote device 702 includes a display 722. The display 722 can display information on the operation of the autonomous work vehicle and/or the remote device 702. For example, a video captured by one or more cameras on the autonomous work vehicle (e.g., the cameras 515 of FIG. 5) may be presented on the display 722. Additionally, or alternately, the display 722 can present information on various settings and/or conditions of the autonomous work vehicle and/or the remote device 702, such as battery level, the signal strengths of the wireless connections, and/or notifications or alerts. In some embodiments, the display 722 is a touchscreen display.

Embodiments disclosed herein provide techniques for monitoring the use of the remote device based on one or more signals that are produced (or not produced) by the remote device. For safety reasons, the operator 700 should carry the remote device 702 while the autonomous work vehicle is operating autonomously so that the operator 700 has quick access to the pause button 706 and the stop button 708. When it is determined that the operator 700 is not carrying the remote device 702 (e.g., when the operator 700 has left the remote device 702 hanging from an object), the autonomous work vehicle may be automatically placed in a lower power state, such as a sleep state. Components of the drive system (e.g., motors, transmissions, and/or associated control electronics) can be paused to bring the autonomous work vehicle to a controlled stop or idle. Additionally, in some embodiments, one or more other operations of the autonomous work vehicle may be paused. For example, components of the cutting mechanism (e.g., the mower reel, the cutting blades, and/or associated control electronics) can be paused. In addition to ensuring the operator has access to the safety controls on the remote device while the autonomous work vehicle is operating autonomously, the monitoring of the use of the remote device can reduce the power consumption of the autonomous work vehicle and save battery power. Pausing some operations of the remote device can reduce the power consumption of the autonomous work vehicle by transitioning the autonomous work vehicle from a higher power consumption state to a lower power consumption state. For example, some or all of the operations of the drive mechanism can be paused to save power.

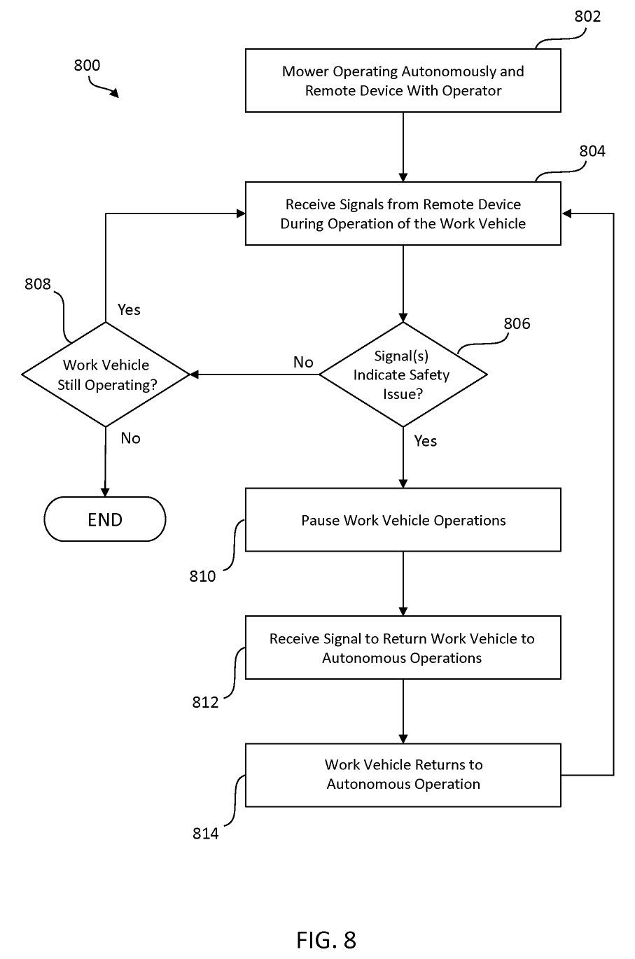

FIG. 8 illustrates a flowchart of an example method 800 of operating an autonomous work vehicle and a remote device 702 according to an embodiment of the disclosure. Initially, as shown in block 802, the autonomous work vehicle may be operating autonomously and the remote device 702 can be operably connected to the autonomous work vehicle and carried by the operator 700. One or more signals may be produced by the remote device 702 periodically or at select times during the autonomous operations of the autonomous work vehicle (block 804). For example, the signal(s) can be produced every two seconds, every five seconds, or every n seconds, where n is a number greater than zero. In one embodiment, the one or more signals are transmitted from the remote device 702 to the autonomous work vehicle for processing.

Based on the signals, or the lack of signals, a determination can be made at block 806 as to whether the signal(s) (or lack of signal(s)) indicates a safety issue is occurring. The signal(s) can indicate the operator 700 of the remote device 702 is misusing the remote device 702. For example, a signal from a touch sensor may not be received because the operator 700 is not holding the remote device 702. As another example, a signal may not be received from a heart rate sensor because the operator 700 is not holding the remote device 702, or the operator 700 is experiencing a medical event. In some instances, a signal can be received from an accelerometer that indicates the remote device 702 is not moving, which can indicate the operator 700 has set the remote device 702 down.

Additionally, or alternately, a signal can be received from the accelerometer that indicates the remote device 702 is moving slightly or in a repeat pattern, which can indicate the operator 700 has hung the remote device 702 on an object (e.g., a tree branch). In this instance, a motion profile of the remote device 702 may be more periodic or repetitive than random.

In another example, signals from the remote device 702 can indicate the movement of the remote device 702 matches or substantially matches the movement of the autonomous work vehicle, which may indicate the operator 700 has set the remote device 702 on the autonomous work vehicle while the autonomous work vehicle is operating autonomously. The signals from one or more sensors, such as the position sensors and/or the GNSS, on the autonomous work vehicle can be compared to the signals from similar sensor(s) on the remote device 702 to determine if the signals produced at the remote device 702 match or substantially match the signals produced at the autonomous work vehicle.

In some embodiments, to operate effectively, the remote device 702 should be located within a given range or distance of the autonomous work vehicle. In some cases, however, the operator 700 may move to a location that is outside the range of the autonomous work vehicle. The distance between the location of the autonomous work vehicle and the location of the remote device 702 may exceed a threshold. In such instances, the safety controls on the remote device 702 may not act on or control operation of the autonomous work vehicle. Based on this misuse of the remote device 702, the movement of the autonomous work vehicle may be paused (e.g., temporarily stopped). Additionally, or alternatively, some of the operations of the autonomous work vehicle (e.g., operation of the cutting mechanism or other attached implement) may be paused.

At block 806 and based on a determination that the signal(s) do not indicate misuse of the remote device 702 or a safety issue, the method may continue at block 808 where a determination may be made as to whether the autonomous work vehicle is still operating or operating autonomously. The method may end if a determination is made that the autonomous work vehicle is not operating or not operating autonomously. When a determination is made at block 808 that the autonomous work vehicle is still operating autonomously, the method can return to block 804.

Returning to block 806, if a determination is made that the signal(s) indicate a safety issue or misuse, the method may pass to block 810 where some operations of the autonomous work vehicle are paused. In some embodiments, some or all of the components of the drive system are paused to bring the autonomous work vehicle to a controlled stop or idle. Additionally, in some embodiments, one or more operations of the cutting mechanism may be paused to reduce the power consumption of the autonomous work vehicle and save battery power.

At block 812, one or more signals may be received that indicate the safety issue or the misuse of the remote device 702 is ended. The autonomous work vehicle can return to autonomous operations and transition back to the higher power consumption state. In some embodiments, the signal(s) are produced by the remote device 702 as a result of the operator 700 picking up and carrying the remote. The position sensors and/or another sensor, such as the GNSS, can provide signals that indicate the remote device 702 is in motion. In another embodiment, the operator 700 may activate a button on the remote device 702, such as the pause button, to transmit the signal(s) to the autonomous work vehicle. In some instances, the signals are provided based on the operator 700 performing both operations, including picking up and carrying the remote device 702 and activating an input element on the remote device 702.

When the remote device 702 is located outside the range of the autonomous work vehicle, and as a result some operations of the autonomous work vehicle have been paused, the autonomous work vehicle may automatically return to autonomous operations based on the operator 700 carrying the remote device 702 and moving to a location that is within the range of the autonomous work vehicle. The position sensors and/or another sensor, such as the GNSS, on the autonomous work vehicle and on the remote device 702 can provide signals that indicate the location of the remote device 702 and the location of the autonomous work vehicle. When the distance between the location of the remote device 702 and the location of the autonomous work vehicle is below the threshold, the autonomous operation of the autonomous work vehicle may resume. In some embodiments, the operator 700 must perform three operations that include carrying the remote device 702, moving to a location within the range of the autonomous work vehicle, and activating an input element on the remote device 702. In some embodiments, the operator 700 may active the input elements on the remote device 702 prior to the remote device 702 sending signals indicating the position of the remote device.

The operations of the autonomous work vehicle that were paused at block 810 may resume normal operations at block 814 when the autonomous work vehicle returns to autonomous operations. The autonomous work vehicle may transition back to the higher power consumption state at block 814. The method may then return to block 804.

In one embodiment, the signals produced by the remote device 702 are received by the autonomous work vehicle (block 804). A computing unit of the autonomous work vehicle (e.g., the computing unit 525 of FIG. 5) may determine whether the signal(s) indicate misuse of the remote device 702 or a safety issue is occurring (block 806), to determine whether the autonomous work vehicle is still operating or operating autonomously (block 808), and to pause some of the operations of the autonomous work vehicle (block 810). Continuing with this example embodiment, the operator 700 can pick up and carry the remote device 702 and/or press a button on the remote device 702 (e.g., the pause button) to cause one or more signals to be transmitted to the autonomous work vehicle to cause the autonomous work vehicle to return to autonomous operations (block 812).

In another embodiment, the signals produced by the remote device 702 are received at the remote device 702 (block 804). The remote device 702 may determine whether the signal(s) indicate misuse of the remote device 702 or a safety issue is occurring (block 806), to determine whether the autonomous work vehicle is still operating or operating autonomously (block 808), and to cause some of the operations of the autonomous work vehicle to be paused (block 810). The operator 700 can pick up and carry the remote device 702 and/or press a button on the remote device 702 (e.g., the pause button) to cause one or more signals to be transmitted to the autonomous work vehicle to cause the autonomous work vehicle to return to autonomous operations (block 812). The remote device 702 can receive signals from the autonomous work vehicle to enable the remote device 702 to determine whether the autonomous work vehicle is still operating or operating autonomously, and the remote device 702 may transmit one or more signals to the autonomous work vehicle to cause some of the operations of the autonomous work vehicle to be paused.

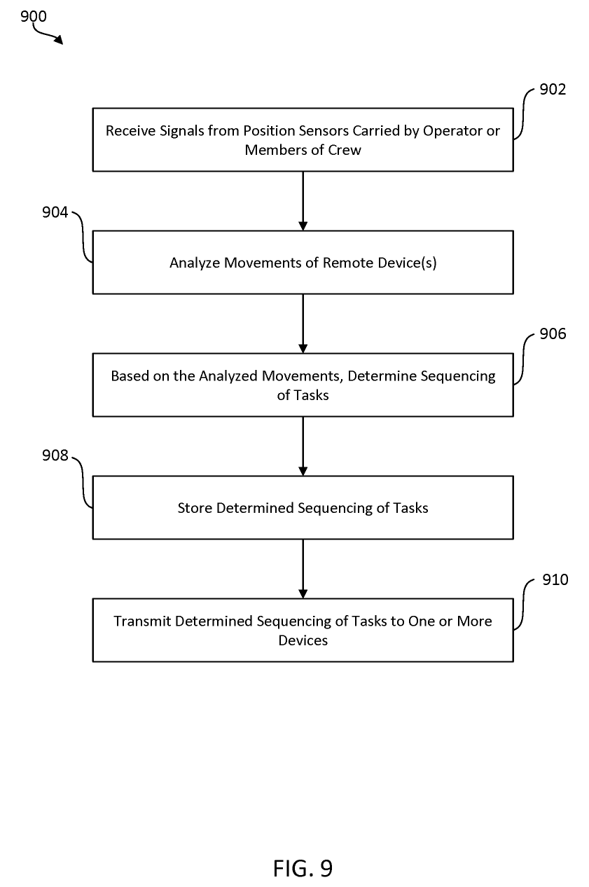

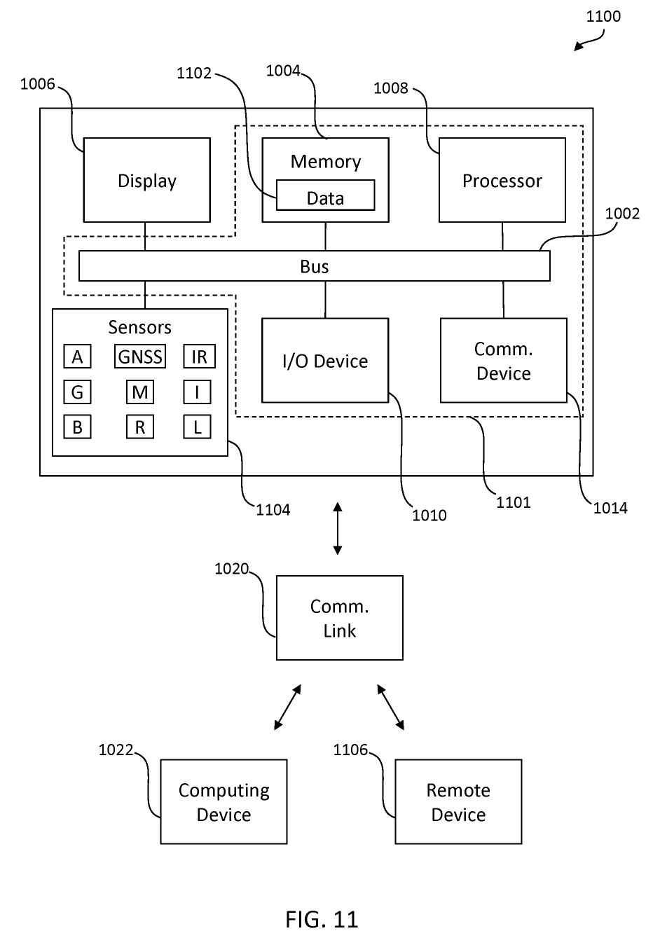

FIG. 9 illustrates a flowchart of an example method 900 of determining work routes according to an embodiment of the disclosure. The method 900 may be performed by an autonomous work vehicle, a remote device 702, or a separate computing device, such as the computing device 1022 shown in FIG. 10 and FIG. 11. At block 902, signals may be received from position sensors that are carried by one or more members of a landscaping crew (or other crew in another environment). The position sensors can be located in a remote device 702 that is carried by the operator 700, remote devices 702 that are carried by each member of the landscaping crew, in a vest that is carried (e.g., worn) by the operator 700 of the remote device 702, or in vests that are carried (e.g., worn) by each member of the landscaping crew. In one embodiment, the position sensors are accelerometers. In another embodiment, the position sensors are GNSSs.

At block 904, the movements of the operator 700 and/or members of the landscaping crew are analyzed based on the signals received at block 902. The signals may be analyzed by one or more processors executing a software application (i.e., processor-executable instructions). Additionally, or alternately, the signals can be analyzed by one or more artificial intelligence (AI) systems (e.g., algorithms), such as machine learning systems, neural networks, and other types of AI systems.

The signals may be analyzed to determine the optimum or improved sequencing of tasks performed by the operator 700 or the members of the landscaping crew. For example, the movements of the operator 700 or members of the landscaping crew can be analyzed based on the type of tools that are used by each person while working in a landscaping area and with the goal of reducing the number of times the person has to switch from one tool to another. In some embodiments, the movements of the members of the landscaping crew may be analyzed to identify more efficient work routes within the landscaping area. For example, one crew member may move often around the landscaping area while another crew member moves less (e.g., based on the type of tasks the crew member is performing). The movements of the crew members can be analyzed to better distribute the tasks to the crew members. For example, the crew members may be assigned to work specific areas within the landscaping area to limit the number of tool changes by the crew members and/or to more equalize the movements the crew members.

At block 906, a sequence of tasks for the operator 700 or for each crew member may be determined. The determined sequencing of tasks for the operator 700 or for each crew member may be stored at block 908. For example, the determined sequencing of tasks can be stored in one or more memories, such as a memory on the autonomous work vehicle, a memory on a remote device 702, and/or a memory in a computing device (e.g., the computing device 1022 shown in FIG. 10).

The determined sequencing of tasks may be transmitted to one or more devices at block 910. For example, the determined sequencing of tasks can be transmitted to a computing device accessible by a manager of the operator 700 or the landscaping crew. Additionally, or alternatively, the determined sequencing of tasks may be transmitted to one or more computing devices that are accessible by the operator 700 or the members of the landscaping crew. In some embodiments, the determined sequencing of tasks can be transmitted to the remote device 702 carried by the operator 700 or to one or more remote devices 702 carried by one or more members of the landscaping crew and displayed on a display screen of the remote device(s) 702 (e.g., the remote device 702 and the display 722 shown in FIG. 7).

FIG. 10 illustrates a block diagram of an example computational system 1000 of the remote device 702 according to an embodiment of the disclosure. The computational system 1000 can be implemented at the remote device 702 shown in FIG. 7 in some embodiments. The computational system 1000 can include one or more communication structures, such as a bus 1002 (e.g., an address bus and a data bus) or other communication mechanism for communicating information and interconnecting subsystems and devices, such as memory 1004, a display 1006, a processor 1008, an input/output (I/O) device 1010, sensors 1012, and a communications device 1014. Although only one of each component is shown in FIG. 10, other embodiments can include one or more of the bus 1002, the memory 1004, the display 1006, the processor 1008, the I/O device 1010, the sensors 1012, and/or the communications device 1014.

The memory 1004 may be configured to store information, such as software applications, data, and processor-executable instructions (collectively data 1016). In one embodiment, the data 1016 can include data associated with the autonomous operation of an autonomous work vehicle. For example, the data 1016 may include processor-executable instructions for receiving and analyzing signals from the sensors 1012, the communications device 1014, the I/O device 1010, and the display 1006. The processor-executable instructions may further include instructions for transmitting signals to an autonomous work vehicle, such as signals from at least some of the sensors 1012 and/or the communications device 1014 (e.g., using one or more antennas). In some embodiments, the processor-executable instructions include instructions for performing the operations in at least blocks 804, 806, and 808 and to cause the operations in blocks 810 and 812 shown in FIG. 8, and/or in one or more of the blocks 902, 904, 906, 908, 910 shown in FIG. 9. The data 1016 can include different or additional data in other embodiments.

The memory 1004 may be implemented as one or more types of volatile and non-volatile memory. For example, the memory 1004 can be a read only memory (ROM), dynamic and/or static random-access memory (RAM), flash memory, cache memory, erasable programmable ROM (EPROM), electrically erasable programmable ROM (EEPROM), virtual memory, optical memory, magnetic memory, and combinations thereof.

In some embodiments, the processor 1008 includes hardware for executing processor-executable instructions, such as the instructions in a software application and the instructions stored as data 1016. The processor 1008 includes circuitry for performing various processing functions, such as executing specific software for specific calculations or tasks. For example, the processor 1008 may be implemented as a microprocessor, a central processing unit, a graphics processing unit, a neural processing unit, a digital signal processor, or combinations thereof.

The bus 1002 can include one or more memory buses (which may each include an address bus and a data bus) that couple the processor 1008 to the memory 1004. In some embodiments, one or more memory management units (MMUs) reside between the processor 1008 and the memory 1004 and facilitate access to the memory 1004 as requested by the processor 1008. In some embodiments, the bus 1002 includes hardware, software, or both coupling components of the computational system 1000 to each other.

The display 1006 includes circuitry and a display screen. The display 1006 is configured to present information on the display screen. The display 1006 can be implemented as the display 722 shown in FIG. 7 in some embodiments. The display 1006 may be configured to include a touchscreen that is operable to display information as well as to receive one or more types of inputs, such as touch inputs, force inputs, and/or gesture inputs.

The I/O device 1010 includes hardware, software, or both, that provide one or more interfaces for communication between the I/O device 1010 and other components within the computational system 1000. One or more of the I/O devices 1010 may enable communication between the operator 700 and the remote device 702. The I/O device 1010 can include, but is not limited to, a keyboard or keypad, a cursor control device, a microphone, speakers, input buttons, and combinations thereof. In some embodiments, the display 1006 may also function as an I/O device when the display 1006 is implemented as a touchscreen display that is configured to receive inputs (e.g., touch, force) as well as display information.

In some embodiments, the sensors 1012 include one or more different types of sensors. For example, the sensors 1012 may include one or more of the following: an accelerometer (A), a GNSS, a heart rate (HR) sensor, a gyroscope (G), a magnetometer (M), an image sensor (I), and other types of sensors. The signals from at least one of the sensors may be used to monitor the use of the remote device 702. For example, the signals from the accelerometer(s) can be used to monitor the use of the remote device 702. Additionally, or alternatively, the signals from the heart rate sensor and/or the GNNS may be used to monitor the use of the remote device 702.

In some embodiments, the communications device 1014 includes hardware, software, or both providing one or more interfaces for communication (such as, for example, packet-based communication) between the remote device 702 and an autonomous work vehicle 1018 (via a communications link 1020). The communications device 1014 may also include hardware, software, or both providing one or more interfaces for communication (such as, for example, packet-based communication) between the computational system 1000 of the remote device 702 and a computing device 1022 (via a communications link 1020). The computing device 1022 can be accessible by a manager of the operator 700 and/or the landscaping crew, by the operator 700, by the members of the landscaping crew, and/or by another person (e.g., a business owner). The computing device 1022 can be one or more computers, one or more cloud-based computing devices, and/or a distributed computing system. Example communications devices 1014 and communications links 1020 include, but are not limited to, a wireless NIC (WNIC) or wireless adapter for communicating via a wireless network, such as a WI-FI network, Bluetooth, LoRa, cellular, and combinations thereof.

According to some embodiments, the computational system 1000 performs specific operations by the processor 1008 executing one or more sequences of one or more processor-executable instructions stored in the memory 1004. For example, processor-executable instructions for the methods and operations described herein may be stored in the memory 1004 and may be executed by the processor 1008. Such processor-executable instructions may be read into the memory 1004 from another computer readable/usable medium, such as removable computer readable/usable medium (e.g., memory sticks, external hard drives). In alternative embodiments, hard-wired circuitry may be used in place of or in combination with processor-executable instructions. Thus, embodiments are not limited to any specific combination of hardware circuitry and/or software. In various embodiments, the term “logic” means any combination of software or hardware that is used to implement all or part of particular embodiments disclosed herein.

FIG. 11 illustrates a block diagram of an example computational system 1000 that can be used to operate an autonomous work vehicle according to an embodiment of the disclosure. The computational system 1100 includes components that are similar to the components of the computational system 1000 shown in FIG. 10. As such, the similar components have the same reference numbers as shown in FIG. 10. For brevity, the similar components will not be described in detail in conjunction with FIG. 11.

The bus 1002, the memory 1004, the processor 1008, the I/O device 1010, and the communications device 1014 collectively are part of a computing unit 1101 of the computational system 1100, such as the computing unit 525 shown in FIG. 5. The memory 1004 is configured to store information, such as software applications, data, and processor-executable instructions (collectively data 1102). In one embodiment, the data 1102 can include data associated with the autonomous operation of the mower 500. For example, the data 1102 may include processor-executable instructions for receiving and analyzing signals from the I/O device 1010, the communications device 1014, the display 1006, and the sensors 1104. The processor-executable instructions may further include instructions for receiving and analyzing signals from the remote device 1106 (via communications link 1020 and the communications device 1014), such as signals from at least some of the sensors 1012 of FIG. 10. In some embodiments, the processor-executable instructions include instructions for performing the operations in one or more of the blocks 804, 806, 808, 810, 812 and 814 shown in FIG. 8, and/or in one or more of the blocks 902, 904, 906, 908, 910 of FIG. 9. The data 1102 can include different or additional data in other embodiments.

In some embodiments, the sensors 1104 include one or more different types of sensors. For example, the sensors 1104 may include one or more of the following: an accelerometer (A), a GNSS, an infrared (IR) signal, a gyroscope (G), a magnetometer (M), an image sensor (I), a bump (B) sensor, a radar (R) sensor, a light detecting and ranging (Lidar) sensor, and other types of sensors. The signals from at least one of the sensors can be used during the operation, including the autonomous operation, of the mower 500. For example, the signals from the accelerometer can be used to detect the motion of the mower 500. Additionally, or alternatively, the signals from the GNSS may be used to detect the position, movement and timing information of the mower 500.

While the above description generally refers to autonomous mowers operating within a landscape management environment, the present disclosure may be applied to other autonomous work vehicles operating in other contexts. For example, the above methods and systems may be applied in an agricultural environment with autonomous work vehicles including, for example, autonomous tractors which may additionally be attached to an (e.g., autonomously controlled) implement. In another example, the above methods and systems may be applied in a construction environment with autonomous work vehicles including, for example, the autonomous yard truck 200 and/or an autonomous bulldozer. Additionally, references made to a “landscaping crew” may be substituted with other groups working cooperatively within an operating environment, such as a construction crew operating within a construction environment, an agricultural crew working within an agricultural environment, or other cooperative group or system.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied – for example, blocks can be re-ordered, combined, and/or broken into sub-blocks. Certain blocks or processes can be performed in parallel.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

### The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. A method, comprising:
receiving, at an autonomous work vehicle operating autonomously, first signals providing a first location of a remote device wirelessly connected to the autonomous work vehicle, the first signals provided by a first global navigation satellite system (GNSS) in the remote device;
providing, by a second GNSS in the autonomous work vehicle, second signals providing a second location of the autonomous work vehicle operating autonomously;
determining whether a distance between the first location and the second location equals or exceeds a threshold; and
based on a determination that the distance equals or exceeds the threshold, pausing one or more operations of the autonomous work vehicle to cause the autonomous work vehicle to transition from a higher power consumption state to a lower power consumption state.

2. The method of claim 1, the method further comprising:
receiving at the autonomous work vehicle, third signals from the remote device providing a third location of the remote device, the third signals associated with the first GNSS;
providing, by the second GNSS in the autonomous work vehicle, fourth signals providing a fourth location of the autonomous work vehicle operating autonomously;
determining whether a distance between the third location and the fourth location is less than the threshold; and
based on a determination that the distance is less than the threshold, causing the one or more operations of the autonomous work vehicle that were paused to resume operations and cause the autonomous work vehicle to transition from the lower power consumption state to the higher power consumption state.

3. The method of claim 2, further comprising prior to receiving the third signals, receiving one or more fifth signals indicating an activation of an input element on the remote device.

4. The method of claim 1, wherein the first signals further comprise one or more signals provided by an accelerometer in the remote device.

5. The method of claim 1, further comprising:
analyzing movements of the remote device based on the first signals;
determining a sequencing of tasks based on analysis of the movements; and
transmitting the sequencing of tasks to a remotedevice.

6. (canceled)

7. (canceled)

8. The method of claim 1, further comprising:
prior to pausing the one or more operations of the autonomous work vehicle, determining whether the autonomous work vehicle is still operating autonomously; and
the one or more operations of the autonomous work vehicle are paused based on a determination that the autonomous work vehicle is still operating autonomously.

9. The method of claim 1, wherein pausing one or more operations of the autonomous work vehicle comprises pausing operations of a drive system of the autonomous work vehicle or a cutting mechanism of the autonomous work vehicle.

10. (canceled)

11. A system, comprising:
an autonomous work vehicle, comprising:
a first processor; and
a first memory storing processor-executable instructions, that when executed by the first processor, cause operations to be performed, the operations comprising:
receiving one or more first signals from a remote device wirelessly connected to the autonomous work vehicle, the one or more first signals provided by a first global navigation satellite system (GNSS) in the remote device;
receiving one or more second seconds from a second GNSS in the autonomous work vehicle;
determining whether a first location of the remote device provided by the one or more first signals and a second location of the autonomous work vehicle provided by the one or more second signals indicate a misuse of the remote device by an operator of the remote device; and
based on a determination that the misuse of the remote device is indicated, pausing one or more operations of the autonomous work vehicle; and
a remote device operable to connect wirelessly to the autonomous work vehicle, the remote device comprising:
the first GNSS;
a second processor; and
a second memory storing processor-executable instructions, that when executed by the second processor, cause operations to be performed, the operations comprising transmitting one or more third signals to the autonomous work vehicle to cause the autonomous work vehicle to resume the one or more operations of the autonomous work vehicle that were paused.

12. The system of claim 11, wherein:
the misuse of the remote device comprises the first location being outside a range of the autonomous work vehicle; and
the one or more third signals are transmitted to the autonomous work vehicle when the operator carrying the remote device moves to a third location that is within the range of the autonomous work vehicle.

13. The system of claim 11, further comprising:
prior to pausing the one or more operations of the autonomous work vehicle, determining whether the autonomous work vehicle is still operating autonomously; and
the one or more operations of the autonomous work vehicle are paused based on a determination that the autonomous work vehicle is still operating autonomously.

14. The system of claim 11, wherein pausing one or more operations of the autonomous work vehicle comprises pausing operations of a drive system of the autonomous work vehicle or pausing some or all of the operations of a cutting mechanism of the autonomous work vehicle.

15-20. (canceled)

21. A method, comprising:
receiving, at an autonomous work vehicle operating autonomously, signals from a remote device wirelessly connected to the autonomous work vehicle, the signals associated with an accelerometer in the remote device;
determining whether the signals indicate a safety issue with a use of the remote device by an operator of the remote device; and
based on a determination that the signals indicate the safety issue, pausing one or more operations of the autonomous work vehicle to cause the autonomous work vehicle to transition from a higher power consumption state to a lower power consumption state.

22. The method of claim 21, wherein:
the signals comprise first signals; and
the method further comprises:
receiving at the autonomous work vehicle, second signals from the remote device, the second signals associated with the accelerometer;
based on the second signals, determining that the safety issue has ended; and
causing the one or more operations of the autonomous work vehicle that were paused to resume operations and cause the autonomous work vehicle to transition from the lower power consumption state to the higher power consumption state.

23. The method of claim 22, wherein the second signals are received from the remote device based on activation of an input element on the remote device.

24. The method of claim 21, wherein:
the safety issue is the operator not carrying the remote device; and
the signals indicate the remote device is not moving.

25. The method of claim 21, wherein:
the safety issue is the operator not carrying the remote device; and
the signals indicate operator not carrying the remote device.

26. The method of claim 21, further comprising:
prior to pausing the one or more operations of the autonomous work vehicle, determining whether the autonomous work vehicle is still operating autonomously; and
the one or more operations of the autonomous work vehicle are paused based on a determination that the autonomous work vehicle is still operating autonomously.

27. The method of claim 21, wherein pausing one or more operations of the autonomous work vehicle comprises pausing operations of a drive system of the autonomous work vehicle

28. The method of claim 21, wherein pausing one or more operations of the autonomous work vehicle comprises pausing operations of a cutting mechanism of the autonomous work vehicle.

29-40. (canceled)

41. The method of claim 23, wherein:
the safety issue comprises the remote device hanging from an object; and
the second signals are transmitted to the autonomous work vehicle based on the operator picking up the remote device.
